(19) United States
(12) Patent Application Publication
(10) Pub. No.: US 2006/0038855 A1
(43) Pub. Date: Feb. 23, 2006

(54) Inkjet print head with a high efficiency heater and a method of fabricating the same

(76) Inventors: Kyong-Il Kim, Seoul (KR); Myong-Jong Kwon, Suwon-si (KR); Kwang-Ryul Kim, Suwon-si (KR); Nam-Kyun Kim, Seongnam-si (KR); Byung-Ha Park, Suwon-si (KR); Yong-Shik Park, Seongnam-si (KR); Eun-Bong Han, Suwon-si (KR); Young-Ung Ha, Suwon-si (KR); Sung-Joon Park, Suwon-si (KR); Jae-Sik Min, Suwon-si (KR)

Correspondence Address: STANZIONE & KIM, LLP, 919 18TH STREET, N.W., SUITE 440, WASHINGTON, DC, 20006, US

(21) Appl. No.: 11/100,545

(22) Filed: Apr. 7, 2005

(30) Foreign Application Priority Data
Aug. 19, 2004 (KR) 2004-65608

(51) Int. Cl. B41J 2/05

(52) U.S. Cl. 347/56

(57) ABSTRACT

An inkjet print head with a high efficiency heater includes a substrate having an ink-feed hole extending therethrough to receive ink stored in a cartridge, a flow path layer to define an ink chamber in fluid communication with the ink-feed hole, a nozzle plate having a nozzle to discharge the ink from the ink chamber to an exterior, a heater located adjacent to an inner wall of the ink chamber and disposed in contact with the ink in the ink chamber, and a lead electrically connected to the heater. The heater increases thermal efficiency and maintains a stable structure. In addition, since the heater is disposed adjacent to the inner wall of the ink chamber, the heater is barely affected by the ink supply pressure or the cavitation force that results from ink bubbles shrinking.

### CROSS-REFERENCE TO RELATED APPLICATIONS

This application claims the benefit of Korean Patent Application No. 2004-65608, filed Aug. 19, 2004, the disclosure of which is hereby incorporated herein by reference in its entirety.

### BACKGROUND OF THE INVENTION

1. Field of the Invention

The present general inventive concept relates to an inkjet print head with a high efficiency heater and a method of fabricating the same, and more particularly, to an inkjet print head capable of increasing efficiency of a heater to eject ink using pressure generated by boiling the ink, and a method of fabricating the same.

2. Description of the Related Art

An inkjet printer is a device to print a desired image or text by ejecting ink stored in a cartridge, to a recording medium using an ejection mechanism. Typically, the ink is ejected through a nozzle of an inkjet print head. The inkjet printer has been widely used because of its inexpensive cost and the ease with which color may be implemented.

The inkjet print head may be classified as a thermal driving type to eject ink using pressure generated by heating and boiling the ink or a piezoelectric driving type to eject the ink using pressure generated by deforming a piezoelectric material.

FIG. 1 is a cross-sectional view illustrating an example of the thermal driving type head. An inkjet print head 14 is attached to a top surface (i.e., a bottom surface in practice) of a cartridge 10 for storing ink 20. An ink-supply passage 12 for supplying the ink stored in the cartridge 10 to the inkjet print head 14 is formed at the top surface of the cartridge 10. An ink-feed hole 16 in fluid communication with the ink-supply passage 12 is formed at a bottom surface of the inkjet print head 14 to supply the ink 20 into the inkjet print head 14, and the ink 20 supplied through the ink-feed hole 16 is located in an ink channel 18.

Heaters 22 made of a resistance heating element are disposed at both ends of the ink channel 18, and a passivation layer 24 for protecting the heaters 22 from the ink 20 is adhered on a top surface of the heaters 22. The heaters 22 are electrically connected to a pad 26 disposed on a top surface of the inkjet print head 14, and the pad 26 is connected to a controller (not shown) mounted on a printer main body to allow the controller to control the heaters 22.

When a power source is applied to the heaters 22, the ink 20 around the heaters 22 is heated to generate bubbles 30, as illustrated in FIG. 1. The more the heaters 22 are heated, the more the bubbles 30 expand, thereby ejecting an ink droplet 28 by pressure generated. However, heat transfer is performed through only the top surface of the heaters 22, as illustrated in FIG. 1, and therefore the heat generated by a bottom surface of the heaters 22 only increases the temperature of the inkjet print head 14 rather than the ink 20, thereby decreasing a heat transfer efficiency. Moreover, the passivation layer 24 disposed on the top surface of the heaters 22 further decreases the heat transfer efficiency.

In an attempt to solve the problems described above, U.S. Pat. No. 6,669,333 discloses technology, illustrated in FIG. 2A, including an inkjet print head 54 mounted on a cartridge 50 having an ink-supply passage 52 extending therethrough, and a heater 58 to heat ink 11 introduced through an ink-feed hole 56 extending through the inkjet print head 54 and located at a center portion of an ink chamber 57 to heat the ink 11 using both surfaces of the heater 58. The inkjet print head 54 of this technology does not require a passivation layer formed on the surfaces of the heater 58, because the ink 11 used with this technology has a low conductivity as compared to ink used with other conventional inkjet print heads.

As illustrated in FIG. 2A, small bubbles 60 are generated around the heater 58 due to the heat produced by the heater 58. Referring to FIG. 2B, the small bubbles 60 expand due to continuous heating to form a large bubble 63, thereby ejecting an ink droplet 64 from the inkjet print head 54. After the ink droplet 64 is ejected, the large bubble 63 shrinks and disappears in the center portion of the ink chamber 57. A cavitation force (see arrows in FIG. 2B) is generated by the shrinking of the large bubble 63 and may damage the heater 58 in the center portion of the ink chamber 57, since the heater 58 has a thin and narrow heating element shape, as illustrated in FIG. 3.

Additionally, since the heater 58 is located at the center portion of the ink chamber 57 suspended above the ink feed hole 56, the heater 58 is subjected to pressure when the ink 11 is ejected from the ink chamber 57 and more ink 11 is supplied into the ink chamber 57 through the ink-feed hole 56. Therefore, the heater 58 becomes deformed due to the ink supply pressure and may then recover its original shape. This reoccurring deformation and recovery of the heater shape is likely to damage the heater 58.

### SUMMARY OF THE INVENTION

The present general inventive concept provides an inkjet print head including a heater having an extended lifetime when compared with a conventional inkjet print head. The inkjet print head is capable of maintaining high efficiency characteristics, and even though heating is performed at both surfaces of the heater, ink supply pressure is not directly applied to the heater.

The present general inventive concept also provides a method of fabricating the inkjet print head having the characteristics described above.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an inkjet print head including a substrate having an ink-feed hole extending therethrough to receive ink stored in an ink cartridge, a flow path layer to define an ink chamber in fluid communication with the ink-feed hole, a nozzle plate having a nozzle to discharge the ink from the ink chamber to an exterior, a heater located adjacent to an inner wall of the ink chamber and disposed in contact with the ink in the ink chamber, and a lead electrically connected to the heater.

The heater is shaped so that top and bottom surfaces of the heater are exposed to the ink in the ink chamber. The heater may be disposed adjacent to the inner wall of the ink chamber rather than being suspended in the ink chamber above the ink-feed hole. As a result, it is possible to prevent ink supply pressure generated when the ink is supplied from the ink-feed hole into the ink chamber from directly being applied to the surfaces of the heater, thereby preventing the heater from being damaged. Since the nozzle is located above the ink-feed hole in order to minimize ink flow resistance when the ink is flowing out of the ink chamber, a cavitation force that results from bubbles shrinking after an ink droplet is ejected is also not applied to the surfaces of the heater.

The heater and the lead may be integrally formed with each other, and the lead may be disposed in the flow path layer and fixed thereto. That is, since the heater is integrally formed with the lead and the lead is disposed in the flow path layer and fixed thereto, the heater may be stably supported.

The heater may include a support part to support the heater on the substrate. The support part may be a portion of the heater that is bent at one end thereof. The bent end of the support part fixes the heater to the substrate and supports the heater in the ink chamber. Since both ends of the heater are fixed by the lead and the support part, respectively, the heater is stably supported even though pressure generated by the ink flowing into the ink chamber may be applied to the surfaces of the heater. The heater may extend from the inner wall of the ink chamber (i.e., the inner wall of the flow path layer) to the support part in an inclined manner.

The heater may have a thin plate shape having at least one slit disposed therein. The bubbles generated about the heater during the heating may shrink and disappear through the at least one slit after an ink droplet is ejected, thereby minimizing pressure applied to the surfaces of the heater during the shrinking of the bubbles.

The heater may include at least two heaters disposed in the ink chamber, and each of the at least two heaters may be individually operated. The heaters being individually operated enables easy adjustment of sizes of ink droplets ejected from the inkjet print head.

The ink-feed hole may include an inlet port in fluid communication with the ink cartridge and a supply port in fluid communication with the ink chamber on one side and in fluid communication with the inlet port on another side and having an area smaller than the inlet port. Since the heater of the present general inventive concept is located adjacent to the inner wall of the ink chamber, a width of the ink-feed hole may be limited. As a result, a portion of the ink feed hole in contact with the ink cartridge and a portion of the ink feed hole in the ink chamber may have different widths to thereby form a heater installation space and reduce resistance to the ink supplied from the ink cartridge.

The foregoing and/or other aspects and advantages of the present general inventive concept are also achieved by providing a method of fabricating an inkjet print head including forming a passivation layer on a substrate, removing a portion of the passivation layer located where an ink-feed hole is to be formed, forming a lower flow path layer constituting a lower portion of an ink chamber on the passivation layer, forming a heater support part in contact with an inner wall of the lower flow path layer, forming a heater and a lead on top surfaces of the passivation layer, the lower flow path layer, and the heater support part, forming an upper flow path layer constituting an upper portion of the ink chamber on the lower flow path layer, forming a second sacrificial layer having a thickness such that a top surface of the upper flow path layer is covered thereby, polishing the second sacrificial layer to expose the top surface of the upper flow path layer, forming a nozzle plate having a nozzle on the upper flow path layer and the second sacrificial layer, forming the ink-feed hole on a bottom surface of the substrate, and removing the second sacrificial layer and the heater support part.

The method may be performed using a semiconductor manufacturing process, and the respective layers may be formed using a thin film forming method, such as a photoresist method, a sputtering method, a chemical vapor deposition method, or the like. The upper flow path layer and the lower flow path layer may be individually and separately formed in order to deposit a metal layer or a polysilicon layer to form the lead between the upper and lower flow path layers. The upper and lower flow path layers may be combined to form the flow path layer. In addition, the polishing of the second sacrificial layer may be performed using a chemical mechanical polishing (CMP) method.

Further, the heater support part may be formed to temporarily support the heater while forming the metal layer or the polysilicon layer constituting the heater, and may subsequently be removed together with the second sacrificial layer during the manufacturing process. The heater support part may be located to extend from an end of the passivation layer near the ink-feed hole toward the top surface of the lower flow path layer. Accordingly, the support part of the heater may be formed at an end of the heater that is spaced apart (i.e., opposite) from where the heater meets the lower flow path layer.

The top surface of the heater support part may be disposed in an inclined manner with respect to a surface of the substrate. Since the heater is formed on the heater support part, the heater may also be formed at an incline with respect to the surface of the substrate.

In this process, the forming of the heater support part may include forming a first sacrificial layer on the top surfaces of the lower flow path layer and the passivation layer, polishing the first sacrificial layer to expose the top surface of the lower flow path layer, and removing a portion of the first sacrificial layer. Removing the portion of the first sacrificial layer may be accomplished by exposing and developing the first sacrificial layer using a gradation mask to form the inclined heater support. The gradation mask may provide varying exposure to light.

The forming of the heater and the lead may include forming and patterning a conductive layer on the passivation layer, the lower flow path layer, and the heater support by injecting impurities into one of a heater portion of the conductive layer and a lead portion of the conductive layer so that the heater portion has a resistance that is higher than the lead portion. That is, impurities having a relatively high resistance may be injected into the heater portion of the conductive layer to make the heater have a high resistance. Alternatively, impurities having a relatively low resistance may be injected into the lead portion of the conductive layer to make the heater have a relatively high resistance.

The forming of the ink-feed hole may include forming the ink inlet port at the bottom surface of the substrate, and forming the ink supply port at the ink inlet port. That is, the ink-feed hole may be formed by two operations in order to form the ink inlet port and the ink supply port to have different widths.

The forming of each of the ink inlet port and the ink supply port may respectively include applying a photoresist on the bottom surface of the substrate, patterning the photoresist to form an etching mask, and etching an exposed portion using the etching mask.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating a conventional inkjet print head;

FIG. 2A is a cross-sectional view illustrating another conventional inkjet print head;

FIG. 2B is a cross-sectional view illustrating the conventional inkjet print head of FIG. 2A after ink is ejected therefrom;

FIG. 3 is a perspective view illustrating a heater of the inkjet print head of FIG. 2A;

FIG. 4 is a cross-sectional view illustrating an inkjet print head with a high efficiency heater according to an embodiment of the present general inventive concept;

FIG. 5 is a plan view illustrating the inkjet print head of FIG. 4;

FIG. 6 is a perspective view illustrating a passivation layer and a heater of the inkjet print head of FIG. 4;

FIG. 7 is a cross-sectional view illustrating the inkjet print head of FIG. 4, after ink is ejected therefrom;

FIG. 8 is a perspective view illustrating a heater of an inkjet print head according to another embodiment of the present general inventive concept; and

FIGS. 9A to 9M are cross-sectional views illustrating a method of fabricating the inkjet print head of FIG. 4 according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

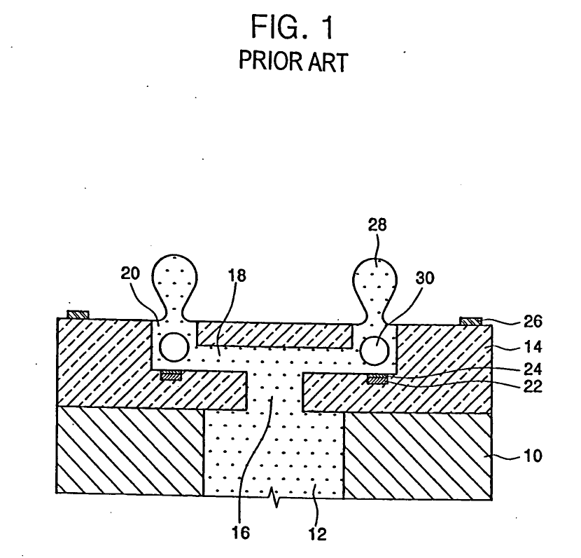

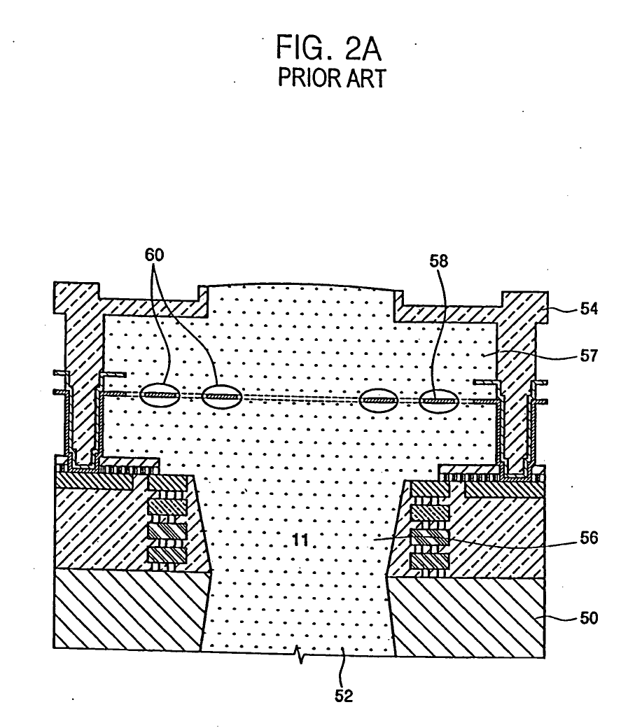

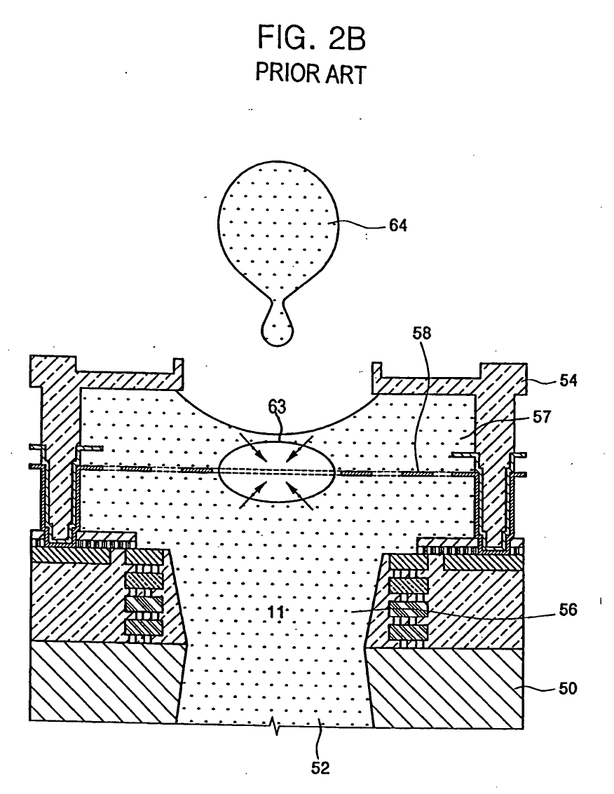

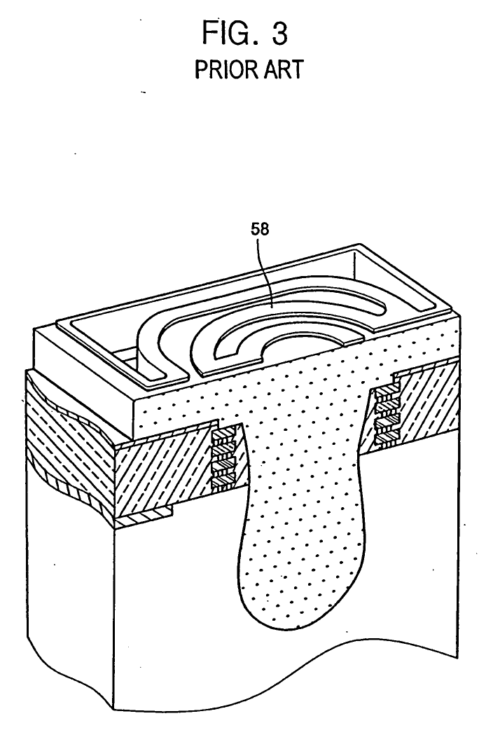

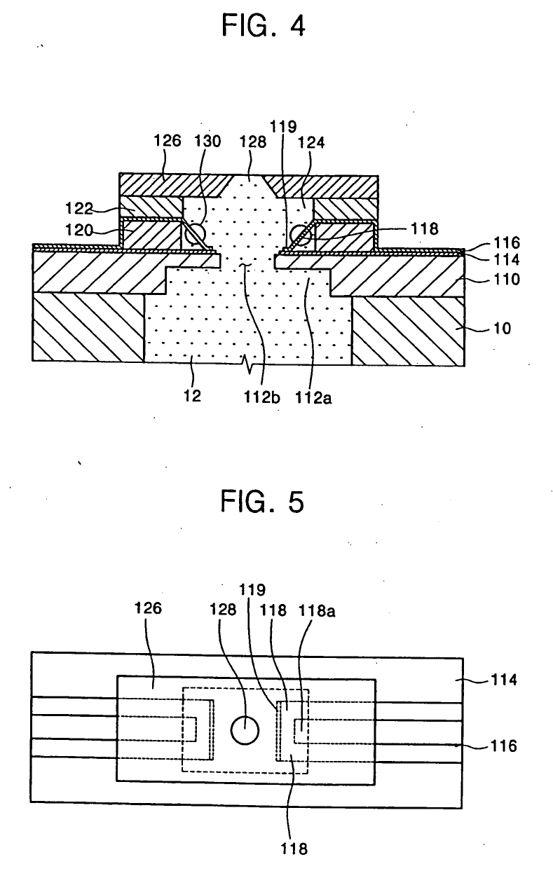

FIG. 4 illustrates an inkjet print head according to an embodiment of the present general inventive concept. A substrate 110 may be made of a silicon wafer, and the substrate 110 may be attached to a top surface (i.e., a bottom surface in practice) of an ink cartridge 10 (similar to FIG. 1) having an ink-supply passage 12 (also similar to FIG. 1) extending therethrough. An ink inlet port 112a is formed at a portion where the substrate 110 is in contact with the ink cartridge 10. The ink inlet port 112a is a hole to introduce the ink stored in the ink cartridge 10 into the inkjet print head, and has a width smaller than that of the ink-supply passage 12. An ink supply port 112b having a width smaller than that of the ink inlet port 112a is formed on the ink inlet port 112a. The ink primarily introduced into the ink inlet port 112a is supplied into an ink chamber 124 through the ink supply port 112b.

A passivation layer 114 may be formed on the substrate 110. The passivation layer 114 may be formed in order to insulate a heater 118 from the substrate 110. The passivation layer 114 may be made of silicon oxide or silicon nitride.

A lead 116 and the heater 118 are formed on the passivation layer 114. The lead 116 and the heater 118 may be made of a metal or a polysilicon thin layer. The heater 118 may be formed to have a relatively high resistance in comparison with the lead 116 by injecting impurities therein. The lead 116 is connected to a flexible printed circuit board (PCB) (not shown) through a TAB bonder, and is mounted on a printer main body to be electrically connected to a controller of the printer main body. Therefore, a pulse current may be applied to the lead 116 by the controller to generate heat from the heater 118, thereby heating the ink around the heater 118.

The lead 116 may be disposed between lower and upper flow path layers 120 and 122, respectively. The lower and upper flow path layers 120 and 122 define an ink chamber 124 to store the ink supplied from the ink supply port 112b. The heater 118 projects from an inner wall between the lower and upper flow path layers 120 and 122 and extends to the passivation layer 114. A remaining portion of the lead 116 extends outside the ink chamber 124. In addition, the heater 118 may be provided with one end supported by the lower flow path layer 120 and located spaced apart from the passivation layer 114, and the other end bent to form a support part 119 in contact with the passivation layer 114. Therefore, the heater 118 is supported by the lower and upper flow path layers 120 and 122 and the passivation layer 114 at its both ends, and may be disposed on the substrate 110 in an inclined manner.

That is, the heater 118 has no unsupported wedged portion that may cause a stress concentration, thereby creating a stable structure. In addition, the heater 118 may include two heaters that are symmetrically disposed on opposite sides of the ink supply port 112b, as illustrated in FIG. 4. Each of the heaters may be individually connected to the controller and may be individually operated, thereby making it easy to adjust a size of the ink droplets to be ejected from the inkjet head.

A nozzle plate 126 (i.e., a nozzle layer) is formed on the upper flow path layer 122, and has a nozzle 128 to eject the ink. Since the nozzle 128 is located above the ink supply port 112b, the ink that is introduced into the ink chamber 124 is ejected without a change in direction of an ink flow path making the ink flow path relatively short. Since there are no obstacles to restrict the ink flow except for openings of the ink supply port 112b and the nozzle 128, an ink flow resistance may be minimized in comparison with some conventional inkjet printer heads that have a heater disposed across an ink feed hole to obstruct ink flowing into an ink chamber. In addition, since the heater 118 is disposed to be in contact with the ink through both surfaces thereof, i.e., top and bottom surfaces, the ink may be ejected using low power. Furthermore, since the heater 118 is disposed adjacent to the inner wall of the lower flow path layer 120 about the ink supply port 112b, the heater 118 is barely affected by ink supply pressure generated while the ink is supplied into the ink chamber 124 from the ink supply port 112b.

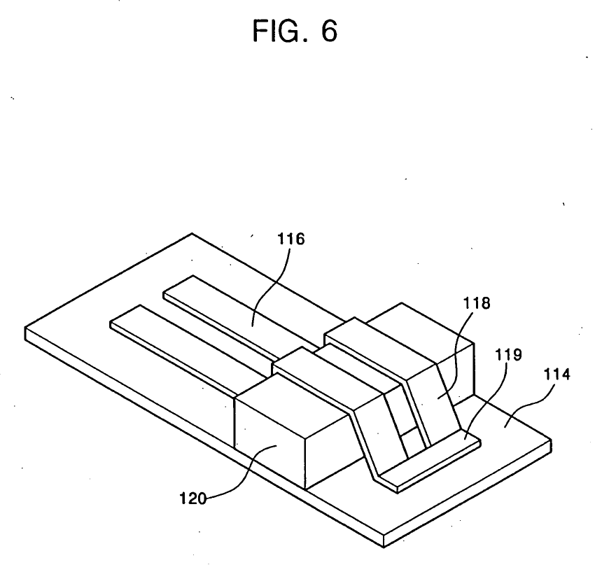

Referring to FIGS. 5 and 6, a structure of the heater 118 is illustrated in detail. That is, a slit 118a may be formed at a center portion of the heater 118 so that the ink may smoothly flow through the slit 118a to the bottom surface of the heater 118.

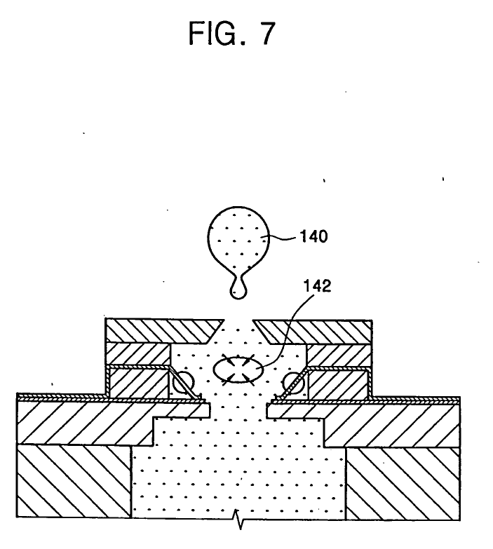

In addition, as illustrated in FIG. 4, bubbles 130 are generated from both of the surfaces of the heater 118. When the bubbles 130 continuously expand due to heating, the bubbles 130 gather in the ink chamber 124 to form a large bubble 142 (see FIG. 7). Once the large bubble 142 is formed, the bubbles 130 formed at the surfaces of the heater 118 shrink and then disappear. Since the bubbles 130 shrink about the slit 118a, the heater 118 is barely affected by a cavitation force generated when the bubbles 130 shrink. This advantage may also be achieved when the heating is performed using a single heater without a slit.

In addition, as illustrated in FIG. 7, the large bubble 142 shrinks after an ink droplet 140 is ejected from the inkjet print head. In this case, the cavitation force is applied toward a center portion of the ink chamber 124 and does not affect the heater 118, because the heater 118 is disposed along the inner walls of the lower flow path layer 120 away from the center portion of the ink chamber 124.

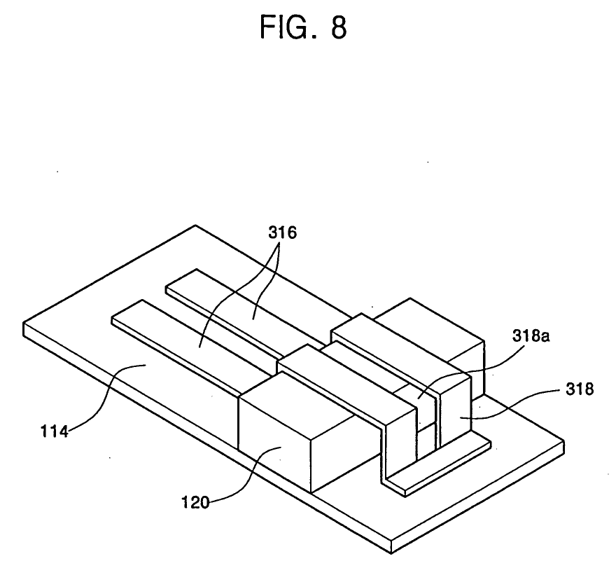

FIG. 8 illustrates a heater 318 and a lead 316 of an inkjet printer head according to another embodiment of the present general inventive concept. The embodiment illustrated in FIG. 8 is similar to the embodiment illustrated in FIG. 6 in that the lead 316 may include two leads and the heater 318 may include two heaters. Although FIGS. 6 and 8 illustrate two heaters and two leads, it should be understood that any number of heaters and leads may be used with the present general inventive concept. In FIG. 8, the heaters 318 are bent at a right angle between top surfaces of the lower flow path layer 120 and the passivation layer 114 rather than having a straight connection therebetween. Each of the heaters 318 has a larger area in contact with the ink than that of the heater 118 illustrated in FIG. 6 to allow the ink to be heated faster. Additionally, since the heater 318 is not formed at an incline like the heater 118 illustrated in FIG. 6, using a gradation mask during the manufacturing process to form a heater support becomes unnecessary.

The heater 318 may be subjected to stress concentration around a bent portion thereof and may be affected more by force applied by the ink supply pressure due to the enlarged ink contact area. However, the increase in the effect of force applied by the ink supply pressure is negligible since the heater 318 is not disposed in the ink flow path, unlike some conventional inkjet print heads.

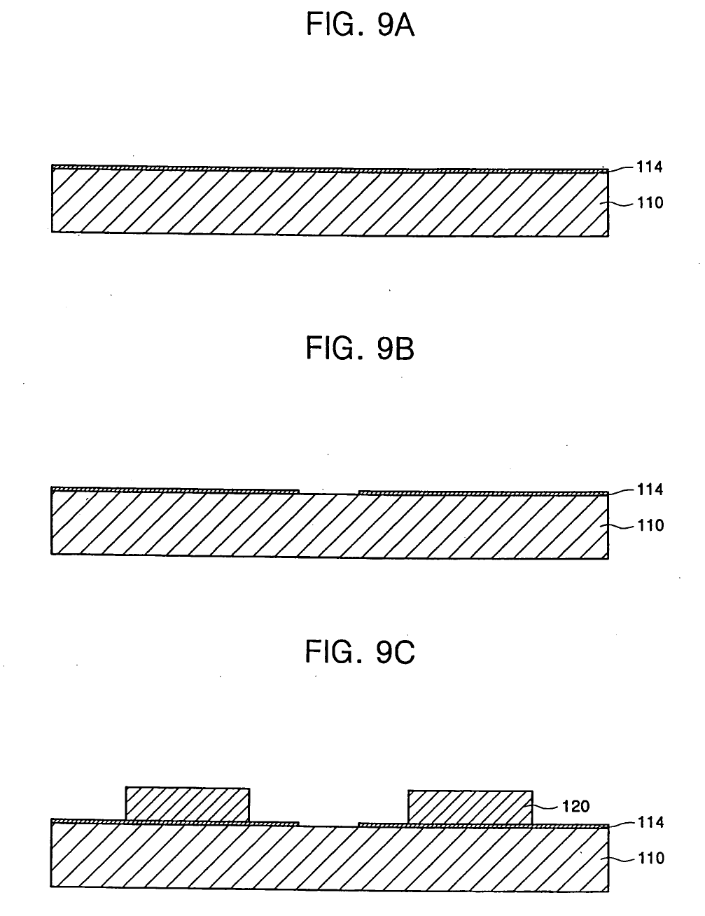

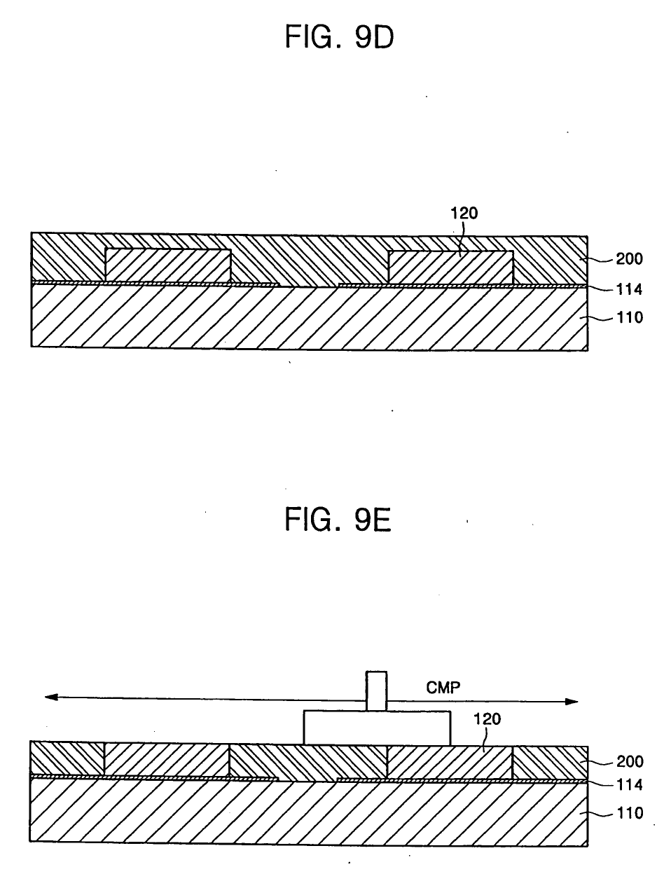

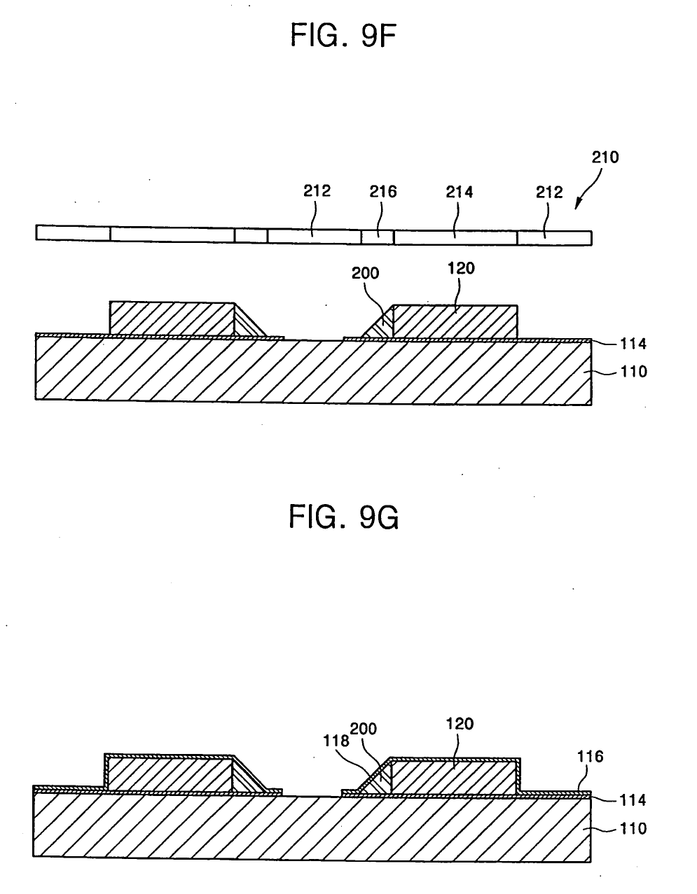

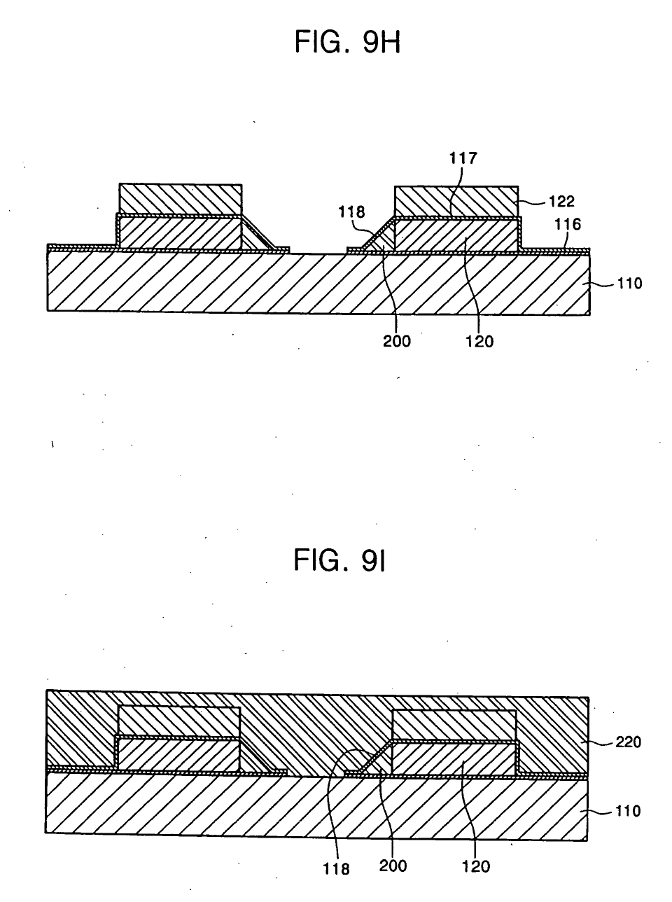

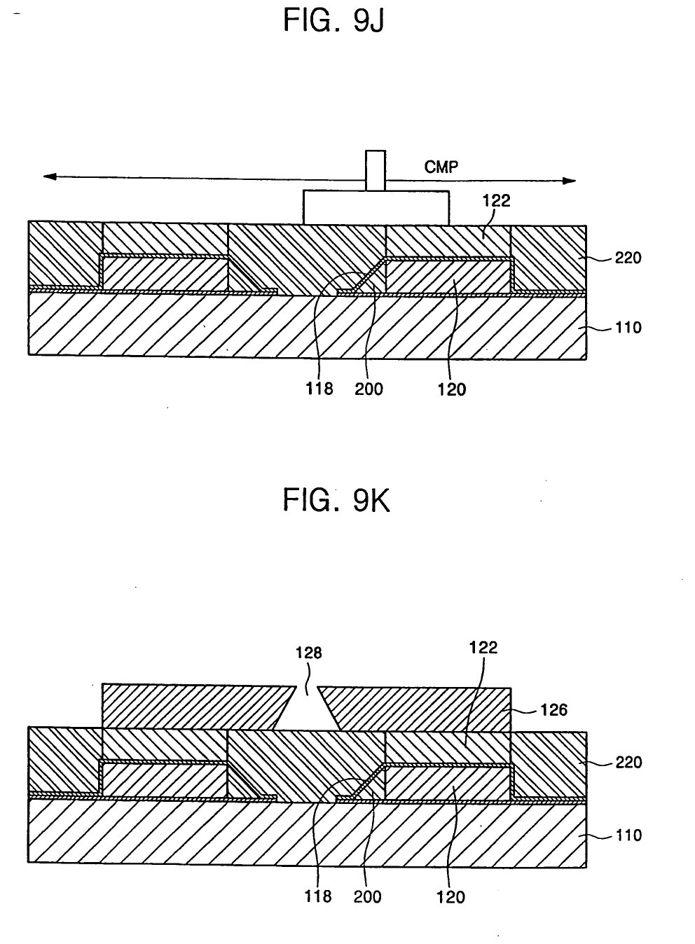

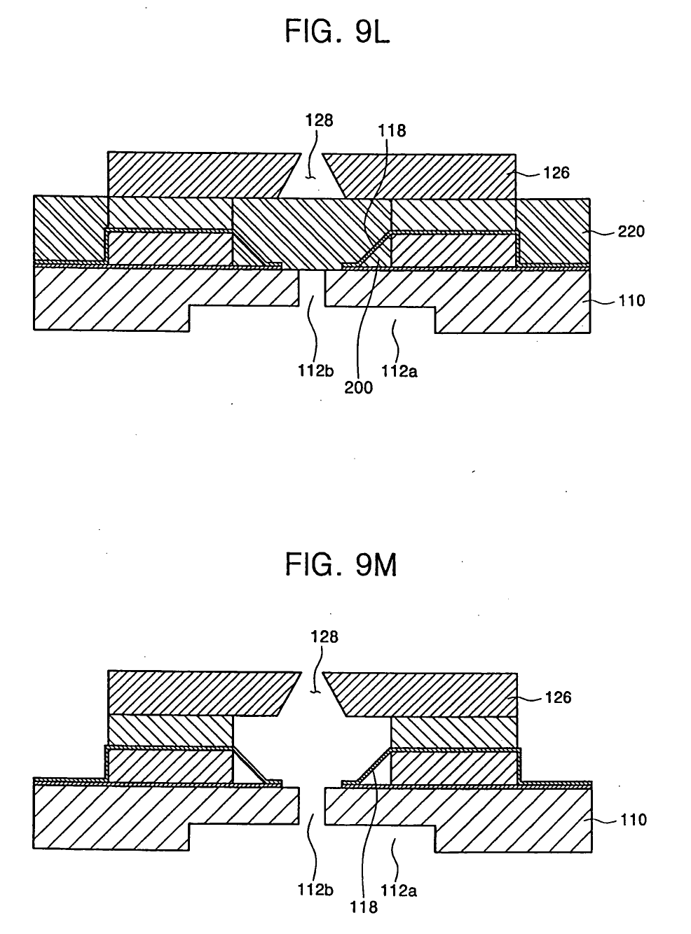

Hereinafter, a method of fabricating an inkjet print head according to an embodiment of the present general inventive concept will be described with reference to FIGS. 9A to 9M.

As illustrated in FIG. 9A, a passivation layer 114 made of a silicon oxide layer or a silicon nitride layer may be formed on a surface of a substrate 110. As illustrated in FIG. 9B, a portion of the passivation layer 114, at which an ink supply port 112b is to be located, is then removed.

As illustrated in FIG. 9C, a photoresist layer having a predetermined thickness may be formed on the passivation layer 114, and a lower flow path layer 120 is formed in the photoresist layer through exposure and development processes around where the ink supply port 112b is to be located. The predetermined thickness that corresponds to a thickness of the lower flow path layer 120 may be determined according to an amount of ink to be ejected in each ink droplet. The photoresist layer may be formed by a spin coating method.

As illustrated in FIG. 9D, once the lower flow path layer 120 is formed, a first sacrificial layer 200 is formed to a thickness such that a top surface of the lower flow path layer 120 is covered. The first sacrificial layer 200 functions as a base on which a metal layer to form a heater 118 is to be deposited. The first sacrificial layer 200 is subsequently removed during the manufacturing process. As illustrated in FIG. 9E, the first sacrificial layer 200 is polished to form a uniform surface using a polishing process. The polishing process is performed until the top surface of the lower flow path layer 120 is exposed. The polishing process may be performed by a chemical mechanical polishing (CMP) method.

As illustrated in FIG. 9F, once the polishing process is completed, the first sacrificial layer 200 is exposed and developed using a mask 210. A remaining portion of the first sacrificial layer 200 that does not include a portion in contact with an inner wall of the lower flow path layer 120 is then removed. The portion of the first sacrificial layer 200 in contact with the inner wall of the lower flow path layer 120 becomes a heater support part to temporarily support the heater 118 during the manufacturing process. The heater support part is located to space the heater 118 apart from an end of the passivation layer 114. The mask 210 may be a gradation mask. As illustrated in FIG. 9F, a triangular cross-section of the heater support part may be obtained using the gradation mask including a light varying portion 216 of the mask 210 to correspond to the heater support part. When a positive photoresist is used, the mask 210 includes a light transmitting part 212, a light blocking part 214, and the light varying portion 216 in which transmittance is continuously varied. Therefore, a depth exposed by the light varying portion 216 during the exposing process continuously decreases in a peripheral direction of the mask 210, and as a result, the heater support part illustrated in FIG. 9F may be obtained through the developing process.

In order to obtain the heater of FIG. 8, the light varying portion 216 may be substituted with another light blocking part 214.

As illustrated in FIG. 9G, once the heater support part is formed, the heater 118 and a lead 116 are formed. The heater 118 and the lead 116 may be obtained by forming a metal layer or a polysilicon layer along a surface illustrated in FIG. 9F using a sputtering method or a chemical vapor deposition (CVD) method, and then patterning the layer according to a desired shape. The desired shape may include a single heater on each side of where the ink supply port 112b is to be formed, or more than one heater on each side of where the ink supply port 112b is to be formed defined by one or more slits. The heater 118 and the lead 116 may be formed of the same material layer, and impurities having a high resistance may then be injected into a heater portion to form the heater 118 to have a higher resistance, or impurities having a low resistance may be injected into a lead portion to form the lead 116 to have a lower resistance. Once the process illustrated in FIG. 9G is complete, the heater 118 has the shape illustrated in FIG. 6.

As illustrated in FIG. 9H, after forming the heater 118 and the lead 116, an upper flow path layer 122 is formed on the lead 116 and the lower flow path layer 120. The upper flow path layer 122 constitutes an ink chamber together with the lower flow path layer 120, and functions to fix the lead 116 at a supported portion 117, thereby supporting the heater 118. Therefore, a thickness of the upper flow path layer 122 is determined based on the thickness of the lower flow path layer 120 and the amount of ink to be ejected in each ink droplet.

As illustrated in FIG. 91, a second sacrificial layer 220 is formed to cover a top surface of the upper flow path layer 122. The second sacrificial layer 220 functions as a base to support a nozzle plate 126. As illustrated in FIG. 9J, once the second sacrificial layer 220 is formed, the second sacrificial layer 220 is polished to expose the top surface of the upper flow path layer 122. The polishing may be performed by a CMP method.

As illustrated in FIG. 9K, once the polishing is completed, a nozzle plate 126 (i.e., a nozzle layer) having a nozzle 128 is formed on the upper flow path layer 122 and over the ink chamber 124. Forming the nozzle plate 126 may be performed by a photoresist method.

As illustrated in FIG. 9L, an ink inlet port 112a and the ink supply port 112b are formed at a bottom surface of the substrate 110 by a dry or wet etching method. The ink inlet port 112a and the ink supply port 112b may be manufactured by a separate etching process, which is performed by applying photoresist on the bottom surface of the substrate 110, patterning the photoresist in the respective shapes of the ink inlet port 112a and the ink supply port 112b to form an etching mask, and etching the photoresist using the etching mask.

The first and second sacrificial layers 200 and 220 may then be removed through the ink inlet port 112a and the ink supply port 112b. The inkjet print head illustrated in FIG. 9M is complete.

As can be seen from the foregoing, the heater of the present general inventive concept comes into contact with the ink through both surfaces thereof to heat the ink, thereby increasing thermal efficiency and obtaining a stable structure since both ends of the heater are supported by the flow path layer and the substrate.

In addition, since the heater is disposed adjacent to the inner wall of the ink chamber away from the ink-supply passage, the heater is barely affected by the ink supply pressure or the cavitation force during the bubble shrinkage. Since the heater and the lead are formed of the same material rather than individually adhered, and impurities are then injected in order to adjust a relative resistance, no problem of separating the heater from the lead arises, thereby minimizing damage to the heater. Further, a plurality of individually operating heaters may be disposed in the ink chamber to readily adjust size of the ejected ink droplets.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet print head, comprising:
a substrate having an ink-feed hole extending therethrough to receive ink stored in a cartridge;
a flow path layer to define an ink chamber in fluid communication with the ink-feed hole;
a nozzle plate having at least one nozzle to discharge the ink from the ink chamber to an exterior;
at least one heater located adjacent to an inner wall of the ink chamber and having top and bottom surfaces disposed in contact with the ink in the ink chamber; and
at least one lead electrically connected to the at least one heater.

2. The inkjet print head according to claim 1, wherein the at least one heater and the at least one lead are integrally formed with each other and the at least one lead is disposed in the flow path layer and fixed thereto.

3. The inkjet print head according to claim 2, wherein the at least one heater includes a support part to support the at least one heater on the substrate and is bent at one end thereof.

4. The inkjet print head according to claim 3, wherein the at least one heater extends in a declining manner from the inner wall of the ink chamber to the support part disposed on the substrate.

5. The inkjet print head according to claim 3, wherein the at least one heater includes a perpendicular part extending away from the support part in a direction perpendicular to the substrate and a parallel part extending from the perpendicular part into the ink chamber in a direction parallel to the substrate.

6. The inkjet print head according to claim 1, wherein the at least one heater has a thin plate shape having at least one slit disposed therein.

7. The inkjet print head according to claim 1, wherein the at least one heater includes at least two heaters disposed in the ink chamber and each of the at least two heaters is individually operated.

8. The inkjet print head according to claim 7, wherein the at least two heaters are disposed on the substrate and on opposite sides of the ink-feed hole with respect to each other.

9. The inkjet print head according to claim 8, wherein the at least two heaters extend from a region of the substrate adjacent to the ink feed hole toward the inner wall of the ink chamber at an incline.

10. The inkjet print head according to claim 9, wherein the incline slopes upward as a distance from the ink feed hole increases.

11. The inkjet print head according to claim 1, wherein the ink-feed hole includes an inlet port in fluid communication with the cartridge, and a supply port in fluid communication with the ink chamber on one side and in fluid communication with the inlet port on another side and having an area smaller than an area of the inlet port.

12. A method of fabricating an inkjet print head, the method comprising:
forming a passivation layer on a substrate;
removing a portion of the passivation layer located where an ink-feed hole is to be located;
forming a lower flow path layer constituting a lower portion of an ink chamber on the passivation layer;
forming a heater support part in contact with an inner wall of the lower flow path layer;
forming a heater and a lead on top surfaces of the passivation layer, the lower flow path layer, and the heater support part;
forming an upper flow path layer constituting an upper portion of the ink chamber on the lower flow path layer;
forming a second sacrificial layer having a thickness such that a top surface of the upper flow path layer is covered thereby;
polishing the second sacrificial layer to expose the top surface of the upper flow path layer;
forming a nozzle plate having a nozzle on the upper flow path layer and the second sacrificial layer;
forming the ink-feed hole on a bottom surface of the substrate; and
removing the second sacrificial layer and the heater support part.

13. The method according to claim 12, wherein the heater support part is located to extend from an end of the passivation layer near the ink-feed hole toward the lower flow path layer.

14. The method according to claim 13, wherein the top surface of the heater support part is disposed in an inclined manner with respect to a surface of the substrate.

15. The method according to claim 12, wherein forming the heater support part comprises:
forming a first sacrificial layer on the top surfaces of the lower flow path layer and the passivation layer,
polishing the first sacrificial layer to expose the top surface of the lower flow path layer, and
removing a portion of the first sacrificial layer.

16. The method according to claim 15, wherein removing the portion of the first sacrificial layer further comprises partially exposing and developing the first sacrificial layer using a gradation mask.

17. The method according to claim 12, wherein forming the heater and the lead comprises:
forming and patterning a conductive layer on the passivation layer, the lower flow path layer, and the heater support, and
injecting impurities into one of a heater portion of the conductive layer and a lead portion of the conductive layer so that the heater portion has a resistance that is higher than the lead portion.

18. The method according to claim 12, wherein forming the ink-feed hole comprises:
forming an ink inlet port at the bottom surface of the substrate; and
forming an ink supply port at the ink inlet port.

19. The method according to claim 18, wherein forming each of the ink inlet port and the ink supply port respectively comprises:
applying a photoresist on the bottom surface of the substrate;
patterning the photoresist to form an etching mask; and
etching an exposed portion using the etching mask.

20. A method of fabricating an inkjet printer head, the method comprising:
forming a first layer of an ink flow structure on a substrate to define an inner wall of the ink flow structure;
forming a sacrificial layer adjacent to the inner wall and having at least one surface that extends from a center region of the substrate to a top surface of the first layer;
depositing a heater layer on the at least one surface of the sacrificial layer and a top surface of the first layer of the ink flow structure;
forming a second layer of the ink flow structure on the first layer of the ink flow structure;
forming a nozzle layer having at least one nozzle; and
removing the sacrificial layer from underneath the heater layer.

21. The method according to claim 20, wherein the sacrificial layer includes at least two surfaces that extend from opposite sides of where an ink feed hole is to be formed to the top surface of the first layer of the ink flow structure at an incline.

22. The method according to claim 20, wherein the at least one surface of the sacrificial layer includes a first surface that extends perpendicular to the substrate in the center region thereof and a second surface that extends parallel to the substrate from the first surface to the top surface of the first layer.

23. The method according to claim 20, further comprising:
forming at least one heater on the at least one surface of the sacrificial layer and at least one lead on the top surface of the first layer of the ink flow structure by patterning the heater layer and injecting impurities in the heater layer so that the at least one heater has a higher resistance than the at least one lead.

24. The method according to claim 20, further comprising:
forming an ink feed hole to extend through the substrate and to supply ink from an ink container to the ink flow structure.

25. The method according to claim 24, further comprising:
forming at least one heater in the heater layer so that the ink supplied by the ink feed hole contacts both sides of the at least one heater.

26. The method according to claim 24, wherein the sacrificial layer is removed from underneath the heater layer through the ink feed hole.

27. The method according to claim 24, wherein the depositing of the heater layer on the sacrificial layer and the first layer of the ink flow path structure further comprises patterning the heater layer to form a plurality of heaters in the heater layer on each side of the ink feed hole.

28. The method according to claim 20, wherein the ink flow structure comprises at least one ink chamber.
